(19) United States
(12) Patent Application Publication
(10) Pub. No.: US 2009/0053537 A1
(43) Pub. Date: Feb. 26, 2009

(54) System and Method For Forming Encapsulated Structures For Metallic Parts

(76) Inventors: Bernd BUELTERMANN, Graz-Weinitzen (AT); Christian GRASCHL, Weitendorf (AT)

Correspondence Address: MAGNA INTERNATIONAL, INC., 337 MAGNA DRIVE, AURORA, ON, L4G-7K1, CA

(21) Appl. No.: 12/190,726

(22) Filed: Aug. 13, 2008

Related U.S. Application Data
(60) Provisional application No. 60/956,818, filed on Aug. 20, 2007.

(51) Int. Cl. B32B 15/04; B05D 3/12; B05D 3/02

(52) U.S. Cl. 428/457; 427/369; 427/370

(57) ABSTRACT

An encapsulated structure for a metallic part is disclosed. The structure includes at least two corrosion inhibiting members which are bonded to the metallic part and to each other to encapsulate the metallic part from the surrounding environment. In one embodiment, the metallic part is a thixomolded magnesium alloy and the corrosion inhibiting members are injection molded thermoplastic members into which the heated metallic part is pressed. The corrosion inhibiting members can also be molded to provide one or more additional desired features.

This application claim the benefits of U.S. Provisional Application No. 60/956,818, filed Aug. 20, 2007.

### FIELD OF THE INVENTION

The present invention relates to a novel system and method of forming an encapsulated structure of a metallic part. More specifically, the present invention relates to a system and method of forming a metallic part, such as a thixomolded magnesium alloy, which is then encapsulated within two or more bodies formed from another material, to inhibit corrosion of the metallic part.

### BACKGROUND OF THE INVENTION

In many environments corrosion of metallic parts is a serious problem. For example, in the automotive field, much effort has been expended to reduce or inhibit corrosion of metallic parts such as body panels and structural members. The anti-corrosion technologies employed including plating the metal parts with metals such as zinc, which resist corrosion, applying anti-corrosion coatings and/or paints to the metal parts, etc.

As such technologies tend to be less than perfect in inhibiting corrosion, in some cases structural members of an automobile or the like are over-designed and manufactured of a larger size, gauge and/or weight to ensure that, even when material is removed or structurally impaired by corrosion, enough material will remain to ensure structural integrity of the member is maintained.

However, the desire to reduce the weight of vehicles, to increase fuel efficiency, conflicts with such over-design strategies. Further, the need to reduce vehicle weight has driven a move to the fabrication of at least some structural members out of more advanced materials than steel.

For example, structural members molded from magnesium alloys, through thixomolding processes, are now being employed in some vehicles. Structural members manufactured by thixomolding processes offer increased strength and reduced weight when compared to similar structural members fabricated from steel and thixomolded structures are being rapidly adopted in new vehicle designs.

However, while thixomolded members offer many desirable advantages over stamped, cast or otherwise formed steel members, magnesium alloys are more susceptible to salt water corrosion, such as that which results from exposure to common road salt. As one of the desired benefits of thixomolding members is the reduced amount of material required, compared to steel, for the specified structural strength, thixomolded members have less material which can be safely compromised by corrosion.

Conventionally, thixomolded parts are painted or otherwise coated to inhibit corrosion, but such conventional approaches all have associated disadvantages including increased manufacturing cycle times, increased expense and limited effective lifetimes.

### SUMMARY OF THE INVENTION

It is an object of the present invention to provide a novel system and method to form an encapsulated structure of a metallic part to inhibit corrosion which obviates or mitigates at least one disadvantage of the prior art.

According to a first aspect of the present invention, there is provided an encapsulated structure for a metallic part, the structure comprising: a formed metallic part which is subject to corrosion; a first corrosion inhibiting member including an inner surface corresponding to a portion of the outer surface of the formed metallic part; at least one other corrosion inhibiting member including an inner surface corresponding to a portion of the outer surface of the formed metallic part, the first corrosion inhibiting member and each of the at least one other corrosion inhibiting members being bonded to each other and to the formed part to encapsulate the formed metallic part from the surrounding environment.

According to yet another aspect of the present invention, there is provided a method of fabricating an encapsulated structure for a metallic part, comprising the steps of: forming a metallic part; forming a first corrosion inhibiting member which has an inner surface complementary to a portion of the formed metallic part; pressing the formed metallic part into the first corrosion inhibiting member to bond the corrosion inhibiting member to the metallic part; forming at least one other corrosion inhibiting member which has an inner surface complementary to a portion of the formed metallic part; pressing each of the at least one other corrosion inhibiting member onto the formed metallic part to bond the at least one corrosion inhibiting member to the metallic part and to each other corrosion inhibiting member to encapsulate the formed metallic part from the surrounding environment.

The present invention provides an encapsulated structure for a metallic part which includes at least two corrosion inhibiting members that are bonded to the metallic part and to each other to encapsulate the metallic part from the surrounding environment. In one embodiment, the metallic part is a thixomolded magnesium alloy and the corrosion inhibiting members are thermoplastic members into which the heated metallic part is pressed.

### BRIEF DESCRIPTION OF THE DRAWINGS

Preferred embodiments of the present invention will now be described, by way of example only, with reference to the attached Figures, wherein:

FIG. 1 shows a perspective view of the structural members in a prior art front end of a pickup truck employing steel structural members;

FIG. 2 shows a perspective view of the structural members in a pickup truck employing at least two magnesium alloy structural members;

FIG. 3 shows an exploded view of an encapsulated structure including a metallic part in accordance with the present invention;

FIG. 4 shows the metallic part of FIG. 3 pressed into and bonded to the metallic part of FIG. 3; and

FIG. 5 shows a cross section through a portion of the finished encapsulated structure for metallic parts of FIG. 3.

### DETAILED DESCRIPTION OF THE INVENTION

While the following discussion refers to a structural member, typically referred to as a “shotgun”, used in the front of a pickup truck, it will be apparent to those of skill in the art that he present invention is not limited to the manufacture of shotguns and can instead be used, as desired, to manufacture a range of structural and/or non structural parts for a wide variety of uses.

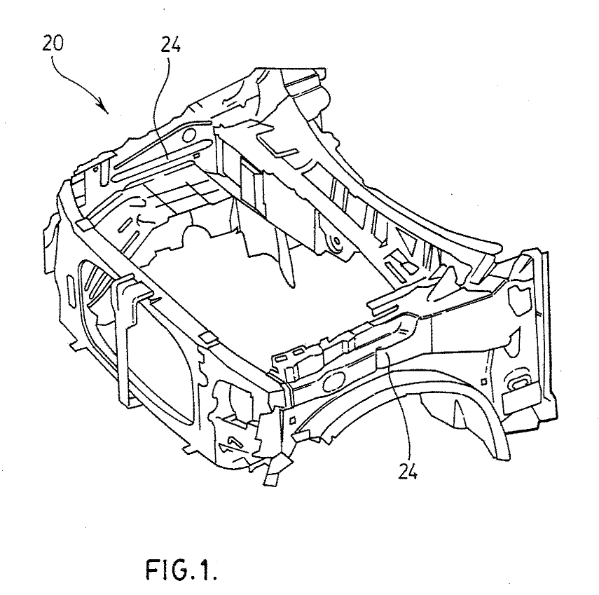

The structural members of the front end of a known pickup truck are indicated generally at 20 in FIG. 1. As shown, the structural members include a pair 24 of formed steel members, typically referred to as “shotguns”, which extend forward from the firewall to the front of the truck and work to stiffen the front end of the truck and carry structural loads. A variety of other components, such as wheel well splash shields, etc., can also be attached to shotguns 24.

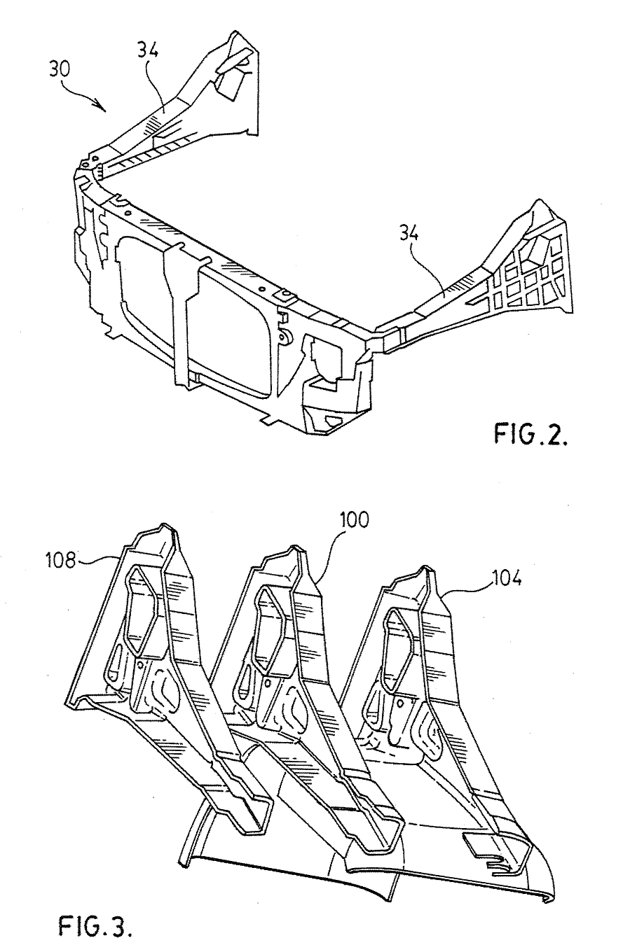

FIG. 2 shows the front structural members, indicated generally at 30, of a known pickup truck where the shotguns 40 are formed by thixomolding a magnesium alloy. While not shown in the Figure, a variety of other components such as wheel well splash shields, etc., can be attached to shotguns 34 as desired.

While magnesium alloy shotguns 34 do provide a significant weight savings when compared to steel shotguns 24, shotguns 34 are subject to corrosion and are typically coated or painted to inhibit such corrosion.

In contrast, in the present invention a shotgun, or other metallic member, is manufactured by thixomolding and is then encapsulated between at least two corrosion inhibiting members.

In a present embodiment of the invention, the corrosion inhibiting members are formed from a thermoplastic material, such as polypropylene, or other suitable corrosion resistant material. The corrosion inhibiting members can be formed from the thermoplastic material in any suitable fashion, such as by injection molding or thermoforming. Each corrosion inhibiting member includes an inner surface which is formed in a shape complementary to the shape of the thixomolded metallic member and includes an outer surface which can be of any desired shape. Preferably, the corrosion inhibiting members have a wall thickness of from about two millimeters to about two point five millimeters.

FIG. 3 shows a magnesium alloy shotgun 100, a first corrosion inhibiting member 104 and a second corrosion inhibiting member 108, prior to assembly, in accordance with the present invention.

In a method in accordance with the present invention, shotgun 100 is thixomolded in a known manner and is trimmed to remove excessive flash. In a preferred embodiment of the invention, this trimming if performed relatively quickly after shotgun 100 is removed from its mold, so that the temperature of shotgun 100 is still in excess of two hundred degrees Celsius.

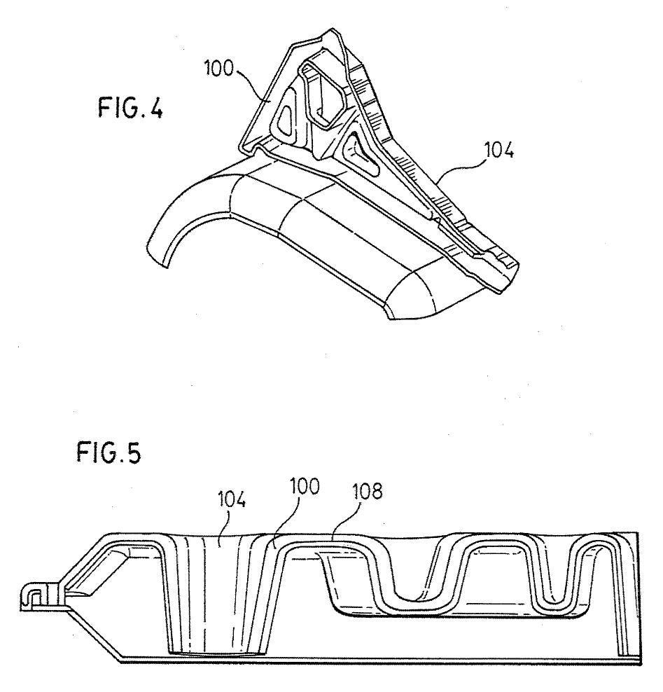

Corrosion inhibiting member 104 is loaded into a press die (not shown) which corresponds to the outer shape of corrosion inhibiting member 104 and then shotgun 100 is pressed into the inner surface of corrosion inhibiting member 104, as shown in FIG. 4, which bonds shotgun 100 to corrosion inhibiting member 104.

Next, corrosion inhibiting member 108 is loaded into a press die (not shown) which corresponds to the outer shape of corrosion inhibiting member 108 and then corrosion inhibiting member 108 is pressed onto the previously made assembly of shotgun 100 and corrosion inhibiting member 104. Again, the temperature of shotgun 100 and the press pressure results in corrosion inhibiting member 108 being bonded to shotgun 100 and to corrosion inhibiting member 104 to obtain the encapsulated structure shown in FIG. 5.

Preferably, shotgun 100 includes one or more through holes in its body which allows portions of corrosion inhibiting member 108 to contact and bond to portions of corrosion inhibiting member 104 through the through holes.

Each of corrosion inhibiting members 104 and 108 are preferably molded with corresponding overlaps which are welded together during the press process to achieve the bonding between the corrosion inhibiting members.

As will be understood, when finished, the encapsulated structure isolates shotgun 100 from the surrounding environment to inhibit corrosion. Further, corrosion inhibiting members 104 and 108 can add to the structural rigidity of the encapsulated structure. In fact, it is contemplated that, in some circumstances, the resulting increase in the rigidity and/or load carrying capability of the encapsulated structure can be a primary advantage of the present invention, as can the reduction in noise and vibration resulting produced by the structure compared to a similar non encapsulated metallic part.

It is contemplated that, under some circumstances, it may be desired to augment the bonding of corrosion inhibiting members 104 and 108 to each other via thermal or sonic welding, or via a suitable epoxy, etc.

It is also contemplated that, in some circumstances, it may not be possible or desired to perform the pressing and bonding of the metallic member to the corrosion inhibiting members while the metallic member retains sufficient heat from the thixomolding process. In such a case, a heating operation can be employed to reheat the metallic member prior to the pressing and bonding operation or, via an inductive heating process, during the pressing and bonding operation, or both.

While the example above only employs two corrosion inhibiting members, it is contemplated that some more complex geometries for the metallic member may necessitate three or more corrosion inhibiting members be pressed and bonded to the metallic member.

Another advantage of the present invention is that other desired features or structures can be molded into one or more of the corrosion inhibiting structures. For example, as shown in FIG. 4, corrosion inhibiting member 104 has been molded with an integral wheel well splash guard and other features, as desired, can be molded into the corrosion inhibiting members.

Further, when such desired features are provided with the structure of the present invention an additional advantage is obtained in that the metallic part can be formed with very tight tolerances as to flatness, alignment, etc. Accordingly, the bonding of the corrosion inhibiting members to the metallic part can align and/or arrange the corrosion inhibiting members, and any desired features formed in them, to achieve tighter tolerances than would otherwise be obtained with features made solely by injection molding or thermoforming, etc.

The above-described embodiments of the invention are intended to be examples of the present invention and alterations and modifications may be effected thereto, by those of skill in the art, without departing from the scope of the invention which is defined solely by the claims appended hereto.

We claim:

1. An encapsulated structure for a metallic part, the structure comprising:
a formed metallic part which is subject to corrosion;
a first corrosion inhibiting member including an inner surface corresponding to a portion of the outer surface of the formed metal part;
at least one other corrosion inhibiting member including an inner surface corresponding to a portion of the outer surface of the formed metal part, the first corrosion inhibiting member and each of the at least one other corrosion inhibiting members being bonded to each other and to the formed part to encapsulate the formed metallic part from the surrounding environment.

2. The encapsulated structure of claim 1 where the metallic part is a thixomolded magnesium alloy.

3. The encapsulated structure of claim 1 where the corrosion inhibiting members are injected molded thermoplastic.

4. The encapsulated structure of claim 1 where the corrosion inhibiting members are thermoformed thermoplastic.

5. The encapsulated structure of claim 1 wherein the outer surface of at least one of the corrosion inhibiting members includes a desired feature.

6. The encapsulated structure of claim 1 wherein the bonding of the corrosion inhibiting members to the metallic part also increase the rigidity of the encapsulated structure.

7. The encapsulated structure of claim 1 wherein the bonding of the corrosion inhibiting members to the metallic part also inhibits vibration of the metallic part.

8. The encapsulated structure of claim 5 wherein the bonding of the corrosion inhibiting members reduces at least some of the tolerances of the desired feature.

9. A method of fabricating an encapsulated structure for a metallic part, comprising the steps of:
forming a metallic part;
forming a first corrosion inhibiting member which has an inner surface complementary to a portion of the formed metallic part;
pressing the formed metallic part into the first corrosion inhibiting member to bond the corrosion inhibiting member to the metallic part;
forming at least one other corrosion inhibiting member which has an inner surface complementary to a portion of the formed metallic part;
pressing each of the at least one other corrosion inhibiting member onto the formed metallic part to bond the at least one corrosion inhibiting member to the metallic part and to each other corrosion inhibiting member to encapsulate the formed metallic part from the surrounding environment.

10. The method of claim 9 where the metallic part is formed by thixomolding.

11. The method of claim 9 wherein the metallic part is heated to assist in bonding the metallic part to the corrosion inhibiting members.
